(19) United States
(12) Patent Application Publication
(10) Pub. No.: US 2026/0105680 A1
(43) Pub. Date: Apr. 16, 2026

(54) IMAGE PROCESSING METHOD AND SYSTEM

(71) Applicant: Sony Interactive Entertainment Inc., Tokyo (JP)

(72) Inventors: Marina Villanueva-Barreiro, London (GB); Andrew Swann, London (GB); Cristian Craciun, London (GB); Pritpal Singh Panesar, London (GB); Radu-Andrei Nedelcu, London (GB); Chockalingam Ravi Sundaram, London (GB); Daniel Montero Motilla, London (GB)

(21) Appl. No.: 19/354,598

(22) Filed: Oct. 9, 2025

(30) Foreign Application Priority Data
Oct. 10, 2024 (GB) 2414912.2

(51) Int. Cl. G06T 15/08; G06N 3/045; G06T 13/60

(52) U.S. Cl. CPC G06T 15/08; G06N 3/045; G06T 13/60

(57) ABSTRACT

There is provided an image processing method for generating images including a volumetric effect. The method comprises obtaining three-dimensional “3D” volumetric effect sampling results from a simulation of a volumetric effect for a first virtual scene, rendering an image of a second virtual scene, inputting the 3D volumetric effect sampling results for the first virtual scene, and the rendered image of the second virtual scene to a neural style transfer “NST” model trained to generate an output image in dependence on a style image and a content image, and generating, by the NST model, an output image for the second virtual scene using the rendered image of the second virtual scene as the content image and the 3D volumetric effect sampling results for the first virtual scene as the style image.

### CROSS-REFERENCE TO RELATED APPLICATIONS

This application claims the benefit of priority to U.K. Application No. 2414912.2, filed on Oct. 10, 2024, the contents of which are hereby incorporated by reference.

### BACKGROUND OF THE INVENTION

### Field of the Invention

The present invention relates to an image processing method and system.

### Description of the Prior Art

The speed and realism with which a scene can be rendered is a key consideration in the field of computer graphics processing. When rendering images for virtual environments, volumetric effects such as fog, smoke, steam and so on may be rendered. Video graphics applications, such as video games, television shows and movies, sometimes use volumetric effects to model smoke, fog, or other fluid or particle interactions such as the flow of water or sand, or an avalanche or rockslide, or fire.

Rendering of fog, for example, typically involves a volumetric rendering approach involving simulation of a three-dimensional fog and sampling of the fog simulation followed by performing rendering operations using results of the sampling. Such volumetric effects may typically be part of a complex rendering pipeline, which may potentially be responsive to a topology of a rendered environment, the textures/colours of that environment, and the lighting of that environment, as well as the properties of the volumetric material itself. These factors may be combined within the operations for rendering the volumetric effect, and this can result in a significant computational cost to the system.

More generally, rendering of volumetric effects can potentially include burdensome processing. For interactive applications, such as video game applications and other similar applications, the associated time and processing constraints can present difficulties in rendering volumetric effects with acceptable quality.

The disclosed technology seeks to mitigate or alleviate these problems.

### SUMMARY

Various aspects and features of the disclosed technology are defined in the appended claims and within the text of the accompanying description and include at least:
In a first aspect, an image processing method is provided in accordance with claim 1.
In another aspect, an image processing system is provided in accordance with claim 18.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:
FIG. 1 is a schematic diagram illustrating an example of an entertainment device;
FIG. 2a is a schematic diagram illustrating an example of a method for rendering images;
FIG. 2b is a schematic diagram illustrating an example of a method for rendering a volumetric effect;
FIG. 3 is a schematic diagram illustrating an example image processing apparatus;
FIG. 4 is a schematic diagram illustrating an example image processing method;
FIG. 5 is a schematic diagram illustrating an example of a view frustum voxel grid;
FIG. 6 is a schematic diagram illustrating a generative adversarial network (GAN);
FIG. 7 is a schematic diagram illustrating a sequence of images of virtual scenes generated in accordance with the disclosed technology; and
FIG. 8 is a schematic diagram illustrating a further example of an image processing method.

### DESCRIPTION OF THE EMBODIMENTS

An image processing method and system are disclosed. In the following description, a number of specific details are presented in order to provide a thorough understanding of the disclosed technology. It will be apparent, however, to a person skilled in the art that these specific details need not be employed to practice the disclosed technology. Conversely, specific details known to the person skilled in the art are omitted for the purposes of clarity where appropriate.

In an example embodiment, a suitable system and/or platform for implementing the methods and techniques herein may be an entertainment device.

Referring now to the drawings, wherein like reference numerals designate identical or corresponding parts, FIG. 1 shows an example of an entertainment device 10 which may be a computer or video game console, for example.

The entertainment device 10 comprises a central processor 20. The central processor 20 may be a single or multi core processor. The entertainment device also comprises a graphical processing unit or GPU 30. The GPU can be physically separate to the CPU, or integrated with the CPU as a system on a chip (SoC).

The GPU, optionally in conjunction with the CPU, may process data and generate video images (image data) and optionally audio for output via an AV output. Optionally, the audio may be generated in conjunction with or instead by an audio processor (not shown).

The video and optionally the audio may be presented to a television or other similar device. Where supported by the television, the video may be stereoscopic. The audio may be presented to a home cinema system in one of a number of formats such as stereo, 5.1 surround sound or 7.1 surround sound. Video and audio may likewise be presented to a head mounted display unit 120 worn by a user 1.

The entertainment device also comprises RAM 40, and may have separate RAM for each of the CPU and GPU, and/or may have shared RAM. The or each RAM can be physically separate, or integrated as part of an SoC. Further storage is provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90, or through one or more of the wired or wireless data ports 60.

An example of a device for displaying images output by the entertainment device is the head mounted display ‘HMD’ 120 worn by the user 1. The images output by the entertainment device may be displayed using various other devices—e.g. using a conventional television display connected to A/V ports 90.

Where components are not integrated, they may be connected as appropriate either by a dedicated data link or via a bus 100.

Interaction with the device is typically provided using one or more handheld controllers 130, 130A and/or one or more VR controllers 130A-L, R in the case of the HMD. The user typically interacts with the system, and any content displayed by, or virtual environment rendered by the system, by providing inputs via the handheld controllers 130, 130A. For example, when playing a game, the user may navigate around the game virtual environment by providing inputs using the handheld controllers 130, 130A.

FIG. 1 therefore provides an example of a data processing apparatus suitable for executing an application such as a video game and generating images for the video game for display. Images may be output via a display device such as a television or other similar monitor and/or an HMD (e.g. HMD 120). More generally, user inputs can be received by the data processing apparatus and an instance of a video game can be executed accordingly with images being rendered for display to the user.

Rendering operations are typically performed by rendering circuitry (e.g. GPU and/or CPU) as part of an execution of an application such as computer games or other similar applications to render image frames for display. Rendering operations typically comprise processing of model data or other predefined graphical data to render data for display as an image frame.

A rendering process performed for a given image frame may comprise a number of rendering passes for obtaining different rendering effects for the rendered image frame. Examples of rendering passes for rendering a scene may include rendering a shadow map, rendering opaque geometries, rendering transparent geometries, rendering deferred lighting, rendering depth-of-field effects, anti-aliasing, rendering ambient occlusions, and scaling among others.

FIG. 2a schematically illustrates an example method of rendering images for display using a rendering pipeline 200. An entertainment device such as that discussed with respect to FIG. 1 may for example implement such a rendering pipeline. The rendering pipeline 200 takes data 202 regarding what is visible in a scene and if necessary performs a so-called z-cull 204 to remove unnecessary elements. Initial texture/material and light map data are assembled 212, and static shadows 214 are computed as needed. Dynamic shadows 222 are then computed. Reflections 224 are then also computed.

At this point, there is a basic representation of the scene, and additional elements 232 can be included such as translucency effects, and/or volumetric effects such as those discussed herein. Then any post-processing 234 such as tone mapping, depth of field, or camera effects can be applied, to produce the final rendered frame 240.

For generating volumetric effects, rendering pipeline techniques may use a volumetric simulation stage followed by a stage of sampling that samples the volumetric simulation. Rendering of volumetric effects, such as fog, smoke, steam, fire and so on typically involve volumetric rendering approaches. The use of volumetric rendering for a scene may be desired for various reasons. However, rendering of scenes with realistic volumetric effects can be computationally expensive.

For convenience, the description herein may refer to ‘fog’ as a shorthand example of a volumetric effect, but it will be appreciated that the disclosure and techniques herein are not limited to fog, and may comprise for example other volumetric physical simulations, such as those of smoke, water, sand and other particulates such as in an avalanche or landslide, and fire.

FIG. 2b schematically illustrates an example method for rendering images with a volumetric effect, such as a volumetric fog effect. The method comprises: performing (at step 2001) a volumetric simulation (e.g. volumetric fog simulation); performing sampling calculations (at a step 2002) to sample the volumetric simulation and obtain a set of sampling results (e.g. stored as a 3D texture); generating (at a step 2003) a 2D volumetric effect image (also referred to herein as a ‘volumetric effect map’ or ‘fog map’) based on the sampling results, e.g. by projecting the sampling results onto a 2D image plane for a virtual camera viewpoint; and rendering (at a step 2004) display images to include a volumetric effect based on the 2D volumetric effect image. The step 2004 may comprise various render passes for providing various rendering effects, in which a volumetric effect rendering pass (e.g. volumetric fog rendering pass) can be used. In some cases, the step 2003 may be omitted and the step 2004 may comprise rendering display images directly based on the sampling results obtained at step 2002.

The volumetric simulation may use any suitable algorithm. For example, fog particles may be simulated or instead a density of fog may be simulated. Interaction of light with the fog can be modelled (e.g. transmission, absorption and scattering of light). The volumetric simulation may be performed only for a portion of an environment that is visible (e.g. a portion of a game world currently within a field of view of a virtual camera). The sampling calculation then samples the volumetric dataset with the results being stored, for example as a 3D texture. The sampling results are then optionally transformed (e.g. via a projection) into a 2D volumetric effect image; this provides an intermediate masked representation of the fog in the scene (i.e. where the fog is present in the scene and at what intensity). Rendering operations can thus be performed to render one or more display images, in which the rendering operations use the results of the sampling and the display images depict the scene with a volumetric effect (e.g. volumetric fog effect).

The sampling at step 2002 may comprise sampling the volumetric simulation using a froxel grid. The sampling is performed at a given predetermined sampling resolution.

As used herein, the term “froxel” connotes a view frustrum voxel (i.e. frustrum-voxel). A froxel grid may comprise frustrum voxels aligned with a virtual camera viewpoint. For instance, a froxel grid may comprise a three dimensional grid of voxels that is warped to map into a virtual camera frustum (i.e. a 3D grid of froxels). Hence the warp acts to convert a rectangular box of voxels into a truncated pyramid of similarly warped voxels fitting within the virtual camera frustum (i.e. froxels). It will be appreciated that in practice there is no warping step per se; simply that is the shape assumed for the froxel grid for the purposes of rendering calculations. The shape of the frustum means that there is a better spatial resolution within the virtual world closer to the virtual camera position.

As used herein, the term “sampling resolution” relates to the number of samples, per virtual scene volume, taken when sampling the computer-generated (e.g. simulated) volumetric effect. When sampling using a 3D grid, the sampling resolution may therefore be defined as the number of samples in each of the height (H), width (W), and depth (D) directions, per unit of virtual scene volume. One set of samples having a higher sampling resolution than another set may therefore relate to the one set comprising more samples than the another set in a given volume of the virtual scene. For example, a higher resolution 3D froxel grid has a greater number of respective froxels for a same given 3D space such that froxels of a smaller size are used in the higher resolution sample set.

An issue with existing approaches is that rendering of volumetric effects can potentially include burdensome processing.

One solution is to sample the volumetric effects at a lower resolution. However, the rendered volumetric effect (e.g. fog) may be of low quality, with poor temporal coherence. For example, sampling a potentially high resolution simulated fog dataset (or calculating values for a specific point to represent a large froxel) can give rise to a blocky simulation and flickering from one frame to the next as the values change.

Embodiments of the present disclosure relate to an image processing method that aims to at least partially alleviate these problems. This includes obtaining (e.g. receiving or generating) 3D volumetric effect sampling results from a simulation of a volumetric effect (e.g. fog) for a first virtual scene (e.g. for a first frame of content), and rendering an image for a second virtual scene (e.g. for a second frame of content). The 3D volumetric effect sampling results for the first virtual scene and the rendered image of the second virtual scene are then input to a neural style transfer (NST) model which generates an output image for the second virtual scene using the rendered image of the second virtual scene as the content image and the 3D volumetric effect sampling results for the first virtual scene as the style image. In this way, the present disclosure allows efficiently generating images including volumetric effects (e.g. fog) by re-using volumetric effect simulation data from one virtual scene for other virtual scenes by transferring the style of the simulation data to images for the other virtual scenes. This allows avoiding having to simulate the volumetric effect for the other virtual scenes, thus reducing computational costs.

Further, by removing the need to obtain the volumetric effect sampling results for the second virtual scene, the present approach allows simulating and/or sampling the volumetric effect for the first virtual scene at a higher resolution. For example, the volumetric effect sampling results for first virtual scenes can be pre-computed at a higher resolution, and then used in real-time as style images for second virtual scenes. Alternatively, for sequences of scenes (e.g. frames), high resolution sampling results may be obtained for some of the scenes (e.g. every X scenes), and neural style transfer techniques can be used to generate images with volumetric effects in-between.

The present approach can therefore provide an improvement in fog effect quality in output images by allowing the volumetric effects to be sampled at a higher resolution at the more infrequent times they are sampled. Further, by using NST for other virtual scenes, the present approach allows reducing computational cost, thus more generally providing an improved balance between display image quality and efficiency.

In addition, the style transfer in the present approach is performed in 3D (e.g. froxel) space, where a style of 3D sampling results is transferred to an image of a virtual scene. In this way, 3D information about the volumetric effect (e.g. fog) is retained in the style transfer process, thus helping ensure that the volumetric effect is transferred in a more realistic manner (e.g. ensuring that a fog effect in image output by the NST model appears realistic). The present 3D approach therefore contrasts with existing 2D style transfer techniques, and the present approach allows providing improved volumetric effect (e.g. fog) quality in the output images. Moreover, using the 3D volumetric effect sampling results directly as the style image removes the need to further process the 3D volumetric effect sampling results (e.g. to convert these sampling results to a 2D representation), thus further improving efficiency.

Accordingly, the present disclosure can allow more efficiently generating one or more display images including a high quality fog effect, or any other volumetric effect.

As used herein, the term “virtual scene” relates to a snapshot of a virtual environment at a particular moment in time. The appearance of a virtual scene may for example be dictated by the objects, textures, and lighting in the virtual environment when the virtual scene is captured. A virtual scene may be associated with a virtual camera viewpoint (i.e. virtual camera angle). The terms “first”, “second”, “third”, etc. as used herein in relation to virtual scenes connote different virtual scenes. These different virtual scenes may originate from different virtual environments (e.g. environments of different videogames) or the same virtual environment. The different virtual scenes may comprise different objects, or the same objects but having different textures or being under different lighting. In some cases, each virtual scene may be associated with an image frame of output content (e.g. for a videogame).

FIG. 3 shows an example of an image processing apparatus 300 in accordance with one or more embodiments of the present disclosure.

The image processing apparatus 300 may be provided as part of a user device (such as the entertainment device of FIG. 1) and/or as part of a server device. The image processing apparatus 300 may be implemented in a distributed manner using two or more respective processing devices that communicate via a wired and/or wireless communications link. The image processing apparatus 300 may be implemented as a special purpose hardware device or a general purpose hardware device operating under suitable software instruction. The image processing apparatus 300 may be implemented using any suitable combination of hardware and software.

The image processing apparatus 300 comprises a sampling processor 310, a rendering processor 320, and a neural style transfer (NST) model 330. The operations discussed in relation to the sampling processor 310, the rendering processor 320, and the NST model 330 may be implemented using the CPU 20 and/or GPU 30, for example. For instance, the NST model 330 may be deployed on the GPU 30.

The sampling processor 310 obtains 3D volumetric effect sampling results from a simulation of a volumetric effect for a first virtual scene. The sampling processor 310 may for example obtain the 3D volumetric effect sampling results by retrieving them from a server device, and/or by simulating and sampling the volumetric effect for the first virtual scene. The rendering processor 320 renders an image of a second virtual scene.

The NST model 330 receives the 3D volumetric effect sampling results for the first virtual scene, and the rendered image of the second virtual scene. The NST model 320 then generates an output image for the second virtual scene using the rendered image as a content image and the 3D volumetric effect sampling results as a style image.

FIG. 4 shows an example of an image processing method 400 in accordance with one or more embodiments of the present disclosure. The method 400 may be used to generate images with volumetric effect (e.g. fog) effects.

A step 410 comprises obtaining a set of 3D volumetric effect sampling results (i.e. sample results) from a computer-generated simulation of a volumetric effect for a first virtual scene. As discussed in further detail below, the 3D volumetric effect sampling results for the first virtual scene are used as a style image in style transfer at step 440.

Obtaining the 3D sampling results of the volumetric effect (e.g. fog) may comprise generating the sampling results. Alternatively, obtaining the sampling results may comprise receiving (i.e. retrieving) the sampling results which have been pre-generated.

Considering generating the sampling results, this may comprise sampling the simulation of the volumetric effect, and in some cases performing the simulation itself. Sampling the simulation may comprise sampling volumetric effect data from the simulation of the volumetric effect for the first virtual scene. The volumetric effect data may be sampled using a 3D grid. The sampling may be performed at a given sampling resolution. A set of sampling results is output by the sampling.

The volumetric effect data being sampled may have been generated using any suitable simulation algorithm. In some cases, obtaining the 3D sampling results may further comprise generating the volumetric effect data by performing the simulation. Alternatively or in addition, pre-generated volumetric effect data may be stored. For example, volumetric effect data may be generated in advance by another data processing apparatus and downloaded to a device performing the image processing method 400. In some examples, volumetric effect data may be generated by another data processing apparatus and streamed (e.g. live streamed) to a device performing the image processing method 400 for sampling thereof.

The volumetric effect data may be generated using any suitable simulation algorithm. In some cases, the volumetric effect data may be generated by a rendering pipeline for a video game or game engine. The Unreal ® game engine is an example of a suitable game engine that can be used for simulating such volumetric effect data. The volumetric effect data can be simulated both spatially and temporally so that the volumetric effect data varies over time and sampling with respect to the volumetric effect data can be performed to sample the volumetric effect data at different points in time (e.g. from frame to frame). For example, in the case of a simulation of volumetric fog effect data, a 3D simulation of respective particles and/or fog density for a portion of a virtual scene within a field of view of a virtual camera may be calculated at various times.

The volumetric effect data may relate to a volumetric effect such as one or more of: a volumetric fog effect, volumetric smoke effect, volumetric water effect, a volumetric fire effect, and/or a volumetric mobile particles effect (e.g. sand, or avalanches, etc.). The sampling results obtained at step 410 may therefore represent one or more of fog, smoke, water, fire, and/or mobile particles.

The sampling of the volumetric effect data may be performed using a 3D grid. Sampling using the 3D grid may comprise performing a 3D sampling calculation for sampling the volumetric effect data. Generally, the 3D volumetric effect data is sampled using a 3D sampling scheme to obtain a set of 3D sampling results. The 3D grid used for the sampling may comprise a frustrum voxel grid (i.e. a froxel grid) comprising frustrum voxels (i.e. froxels).

FIG. 5 schematically illustrates an example of a plan view of a froxel grid.

The 3D froxel grid comprises frustum voxels which fit within the view frustum of the virtual camera, as shown in FIG. 5. In the example shown, the froxels 530 are aligned with a virtual camera viewpoint 510 for a virtual scene. The froxels 530 each define a cell of the froxel grid. The use of such a froxel grid can be beneficial in that frustum-shaped voxels contribute to achieving better spatial resolution for part of a virtual scene closer to the virtual camera position. Sampling using a froxel grid therefore allows improving the efficiency of the sampling process as fewer samples are taken with increasing distance from the virtual camera position.

The example in FIG. 5 shows a view frustum voxel grid including four depth slices 520 in the depth (z) axis for purposes of explanation. In practice, the volumetric effect data may for example be sampled using a froxel grid having dimensions of 64×64×128 (i.e. 2D slices each of 64×64 with 128 slices along the depth axis (i.e. 128 depth slices)), or 80×45×64 or 160×90×128 for a more typical 16:9 aspect ratio image.

Alternatively to a froxel grid, the 3D grid used for sampling at step 410 may comprise a voxel grid with voxels of a uniform shape and volume.

The sampling results may be stored as a 3D array/grid (e.g. H×W×D) for which each entry may be indicative of at least a grayscale value or colour value (e.g. in RGB format). Hence, in some examples a respective sample of the set of sampling results may specify a colour value. For example, for a simulation of a volumetric fog, the sampling may result in obtaining a set of sampling results indicative of colours that are generally white (e.g. grey, off-white and so on) for respective froxels (or voxels). In some embodiments of the disclosure, the sampling may obtain sampling results indicative of both colour and transparency (e.g. a respective sample result may be indicative of an RGBA value, where A is an alpha value between 1 and 0 for indicating transparency).

As noted, in one or more example, the 3D volumetric effect sampling results may be in the form of a forxel grid comprising froxel data for representing a fog effect. The froxel grid may represent only the fog, e.g. without representing other objects in the first virtual scene. Alternatively, the froxel grid may depict both the fog and the first virtual scene more generally.

Each froxel in the froxel grid may have a value of 1 or 0 for indicating presence or absence of fog, respectively (or vice versa). Hence, presence or absence of fog can be specified for each froxel in the froxel grid. In some cases, each froxel may have a value of 1 or 0 and also a transparency value (e.g. an alpha value between 0 and 1) for indicating a transparency for the froxel. The froxel grid may include froxels each having a value for specifying a greyscale value. In some examples, the froxel grid may include froxels each having a value for specifying a colour and also transparency (e.g. RGBA values). For example, in the case of an RGBA format, different shades of white, off-white and grey can be specified as well as transparency for each froxel. Any of the above mentioned froxel grids may be created (e.g. using offline processing) based on a computer-generated fog and sampling thereof.

As discussed in further detail below, generating the sampling results allow generating a style image for use in style transfer in real-time. For example, the first virtual scene may correspond to a first frame of content, and the sampling results generated for the first frame may be used as a style image for generating one or more subsequent frames of the content.

Now considering pre-generated sampling results, obtaining the sampling results may comprise retrieving results that were previously generated (e.g. using the techniques described above). For example, the sampling results may be generated by a remote server, and then transmitted from the remote server to a device performing the image processing method 400.

Alternatively, or in addition, the sampling results may be retrieved from a database storing sampling results for a plurality of different virtual scenes, for later use in style transfer. The database may be stored locally on a device performing the image processing method 400, and/or at a remote (e.g. cloud) server.

In some cases, the sampling results obtained at step 420 may further be upscaled to increase their sampling resolution (i.e. the number of samples per unit virtual volume). The upscaling of the sampling results allows improving the subsequent quality of the style transfer based on the sampling results. Furthermore, the combined process of upscaling the sampling results and style transfer using the upscaled sampling results is more efficient (i.e. has a reduced computational cost) as compared to sampling the volumetric effect at a higher sampling resolution for each virtual scene. The present approach therefore provides an improved balance between efficiency and the quality of volumetric effects in output images.

The upscaling may for example be performed using bicubic interpolation, and/or using an appropriately trained super-resolution machine learning model. The super-resolution machine learning model may for example comprise one or more of: a vision transformer based model (e.g. a Hybrid Attention Transformer (HAN) model), a GAN-based model (e.g. A-ESRGAN, or TecoGAN), a sequential based model (e.g. a Recurrent Neural Network (RNN)), and/or a diffusion model (e.g. Stable Diffusion).

The upscaling is performed by predicting values of new samples, thus increasing the total number of samples and the sampling resolution. Upscaling can be more computationally efficient than sampling the fog at higher resolution and therefore provides a more efficient way to obtain high quality fog effects in display images. The higher resolution sample results following upscaling have an increased sampling resolution relative to the initial sampling results and can be used to provide a higher quality fog effect relative to that achieved using the initial results. Rather than using a high resolution sampling for sampling the computer-generated volumetric effect data and generating a high resolution sample set (which is one possibility), this allows sampling using a lower resolution and using upscaling to generate a higher resolution sample set so as to effectively allow recovery of information. For example, whereas the initial sample set may have a sampling resolution of 64×64×128, the higher resolution upscaled sample set may have a sampling resolution of 256×256×128 (e.g. 4× upsampling in the spatial dimensions of height and width, with the depth dimensions unchanged) or 256×256×512 (e.g. 4× upsampling in each of H, W, and D dimensions).

The upscaling may be performed in 3D (e.g. froxel) space, where a 3D first set of sampling results is upscaled to a 3D second set of sampling results. In this way, 3D information about the volumetric effect (e.g. fog) is retained in the upscaling process, e.g. ensuring that a new fog sample created by upscaling is determined based on fog samples that are actually adjacent in 3D space. This 3D upscaling approach therefore contrasts with existing image upscaling approaches in which upscaling is performed in 2D pixel space as a result of which new pixels can be ‘hallucinated’ (e.g. a new pixel may be added based on neighbouring pixels that relate to objects at entirely different depths). The 3D upscaling approach therefore provides improved volumetric effect (e.g. fog) quality.

It will be appreciated that the present approach removes the need to sample the volumetric effect simulation in real-time for each frame of content and/or allows sampling the volumetric effect simulation to a lower quality thus saving computation costs. Instead, as discussed in further detail below, the present approach uses style transfer techniques to obtain images including volumetric effects by re-using sampling results from different virtual scenes. Accordingly, by reducing the frequency at which volumetric simulations need to be sampled and/or by allowing the sampling to be performed in advance, the present approach allows obtaining higher quality (e.g. higher sampling resolution) sampling results. The volumetric effects obtained via 3D style transfer can therefore be of higher quality (e.g. greater temporal coherence) than those that would be obtained by directly using lower resolution samples.

A step 420 comprises rendering an image of a second virtual scene. As discussed in further detail below, the image of the second virtual scene is used as a content image in style transfer at step 440. The image of the second virtual scene may be referred to as a “content” image or as a “rendered image” below.

The image of the second virtual scene may not include a volumetric effect (e.g. fog) which effect is instead applied thereto via style transfer at step 440. However, it will be appreciated that the image of the second virtual scene may include one or more volumetric effects (e.g. water and fire), with further volumetric effects (e.g. fog) applied thereto via style transfer. Alternatively, or in addition, the image may include a rendered volumetric effect in part thereof, with the volumetric effect being applied to other parts of the image using style transfer. Alternatively, or in addition, the image may include a low quality volumetric effect which acts as a guiding signal for the style transfer at step 440.

The image of the second virtual scene may be rendered using the rendering pipeline 200 described with reference to FIG. 2a. The image of the second virtual scene may comprise a 2D image of the virtual scene. The 2D image may comprise pixel values which may be RGB pixel values. For example, the image of the second virtual scene may be a 24-bit RGB image such that each pixel value has 24-bits with 8-bits per colour channel. Alternatively, another colour space may be used, such as YCbCr colour space.

Alternatively, the image of the second virtual scene may comprise a 3D image (i.e. a 3D representation of the second virtual scene). For example, the image of the second virtual scene may comprise a 3D volumetric image of the second virtual scene. The volumetric image may be stored as a 3D array/grid (e.g. with dimensions H×W×D) that stores information about each point in the 3D grid. The 3D grid may for example comprise a froxel, or a voxel grid. For each point in the grid, the volumetric image may store information such as a grayscale value or colour value (e.g. in RGB or YCbCr format), transparency, and/or density. The 3D grid used for the 3D representation of the second virtual scene may have the same dimensions (e.g. froxels of the same shape) as the 3D grid used to sample the volumetric effect for the first virtual scene. Alternatively, the two 3D grids may have different dimensions.

The image of the second virtual scene may correspond to any suitable content such as a video game or other similar interactive application. The image may be rendered according to any suitable frame rate and any suitable image resolution. In some examples, images may be rendered with a frame rate of 30 Hz, 60 Hz or 120 Hz or any other frame rate.

The first and second virtual scenes correspond to different virtual scenes. The different virtual scenes may differ by at least one of a virtual camera viewpoint, objects in the scene (and/or properties of said objects), and/or lighting of the scene. For example, the first and second virtual scenes may comprise different objects or the same objects but in different lighting or viewed from different virtual camera viewpoints.

In some cases, the two virtual scenes may be unrelated, e.g. the virtual scenes may originate from different content or different virtual environments (e.g. different games). In this way, volumetric effect sampling data obtained for one environment can be efficiently re-used in generating images with volumetric effects (e.g. fog) in another environment.

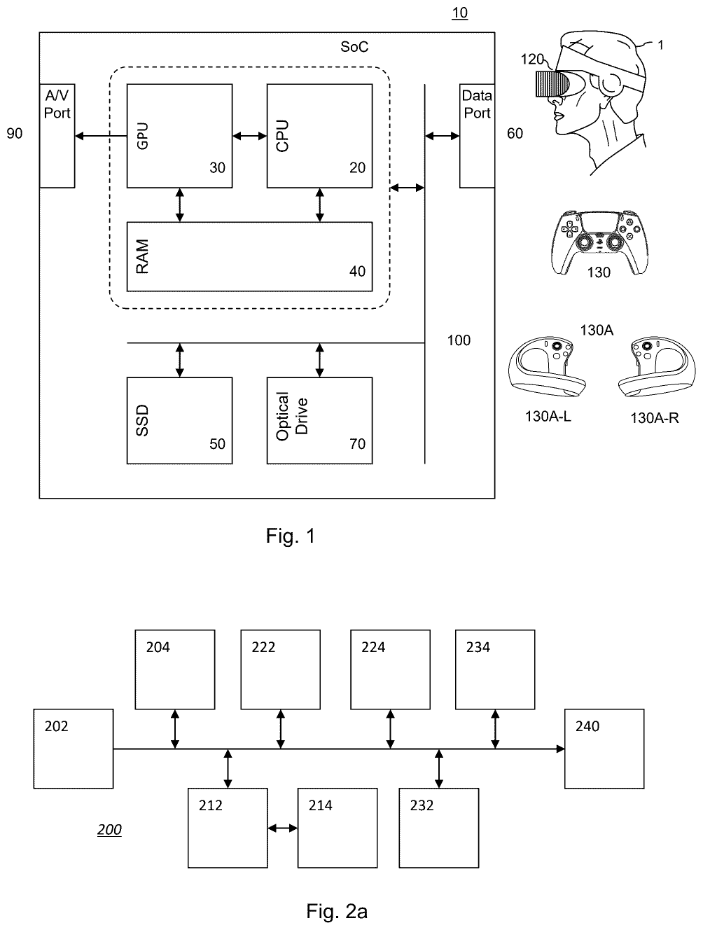

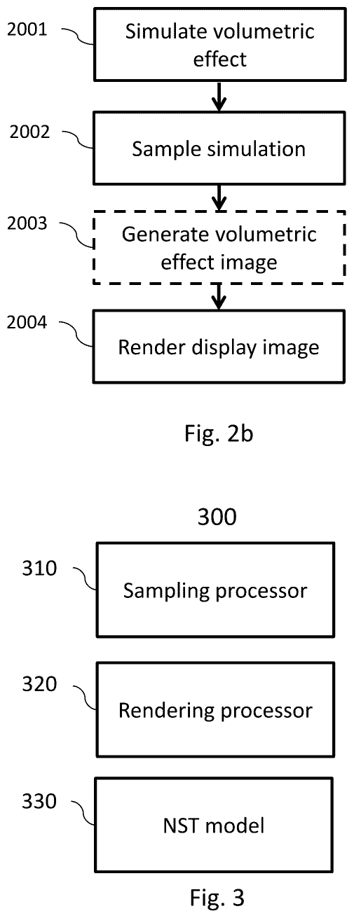

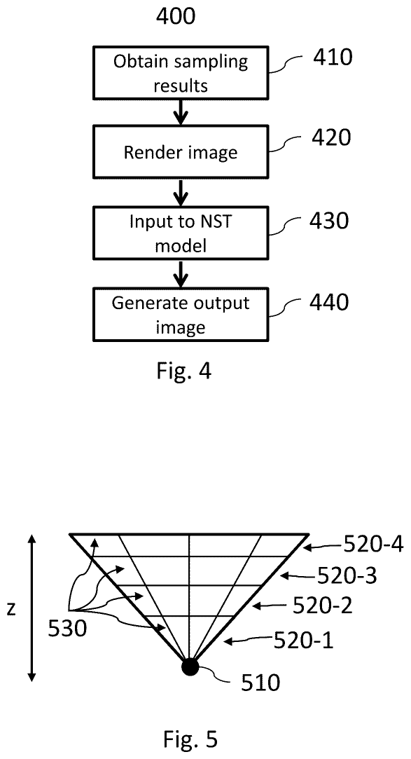

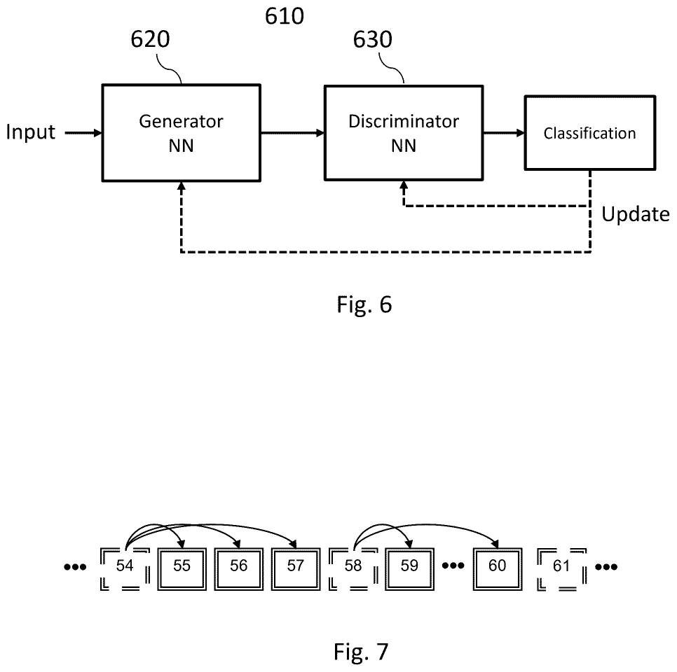

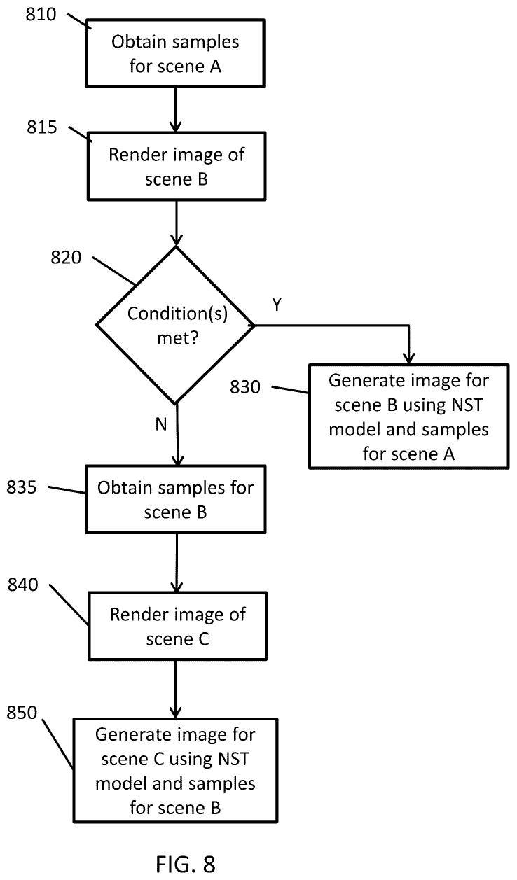

Alternatively, the first and second virtual scenes may relate to the same content, such as to different frames of the same content. As described in relation to FIGS. 7 and 8 below, in these cases, the present style transfer approach allows reducing the frequency at which volumetric effect data needs to be sampled by re-using volumetric effect data between scenes/frames, thus improving the efficiency of generating images for the content.

A step 430 comprises inputting the 3D volumetric effect sampling results for the first virtual scene obtained at step 410, and the image of the second virtual scene rendered at step 420 to a neural style transfer (NST) model.

The NST model is trained to generate a new output image in dependence on a style image and a content image. The aim of the style transfer is generally to obtain an output image that preserves the content of the content image while applying a visual style of the style image. The NST model comprises an artificial neural network (ANN) (implemented in hardware or software or a combination thereof) trained to generate at least one output image in dependence upon an input comprising at least one content image and at least one style image. The ANN may be a processor-implemented artificial neural network which may be implemented using one or more of: one or more CPUs, one or more GPUs, one or more FPGAs, and one or more deep learning processors (DLP).

The NST model may comprise one or more 3D convolutional neural networks (3D CNNs) trained to process input 3D style images to transfer their style onto a 2D or 3D content image. The NST model captures the visual style (e.g. textures, colour, shadows, lighting effects) of the 3D volumetric effect sampling results (e.g. in the form of a froxel grid) and transfers this visual style onto the (typically 2D) content image. The NST model may be trained using a loss function comprising a content loss function that penalizes content changes between the content image and the output image, and a style loss function that rewards similarities in style between the style image and the output image.

The NST model may be trained using a set of training images comprising images of a virtual scene with and without a volumetric effect (e.g. with and without a fog effect).

For example, backpropagation training techniques may be used in which a reference image including a fog effect is used as ground truth data. A backpropagation training method may comprise: inputting an image without a fog effect and a style image (in the form of 3D fog sampling results) including the fog effect to an NST model; generating by the NST model an output image using the input image and the style image; calculating error information according to differences between the output image and the reference image including the fog effect; and updating parameters for the NST model in dependence on the error information. These steps may be repeated until a certain training condition is met. For example, the training condition may be met in response to the error information being indicative of a difference between the output image and the reference image including the fog effect that is less than a threshold, and/or in response to a change in the error information between successive iterations and/or over a predetermined period of time being less than a threshold. More generally, the steps of the training method can be repeated to achieve convergence towards a set of learned parameters for the NST model.

In some examples, a set of training data for training an NST model comprises image pairs for a same virtual scene including a volumetric effect (e.g. fog) and without the volumetric effect (e.g. without fog). Captured image pairs of real world scenes may be used. However, there may be limited availability of such data. Alternatively or in addition, the set of training data may comprise computer-generated image pairs generated by performing offline computer simulations for scenes to simulate the scenes with and without a volumetric effect. In this way, an appearance of a given scene with and without the volumetric effect can be used for training the NST model.

In some examples, an NST model comprises a generative neural network trained to generate an output image using a content image and 3D volumetric effect sampling results as the style image. In some cases, the generative neural network may have been trained using one or more of the above mentioned sets of training data to learn a set of parameters for performing neural style transfer using style images associated with a respective type of volumetric effect (e.g. fog).

Referring now to FIG. 6, in an example the NST model 610 comprises a generative adversarial network (GAN) comprising a generative neural network 620 and a discriminator neural network 630. The generative neural network 620 receives an input comprising a content image for a virtual scene and 3D volumetric effect sampling results (e.g. 3D fog samples) to be used as a style image. The generative neural network 620 generates an output image in dependence on the content image and the 3D volumetric effect sampling results. The output image thus depicts the virtual scene with the volumetric effect (e.g. fog effect). The output image is input to the discriminator neural network 630 which classifies the output image as being either a fake image that is generated by the generative neural network 620 or a real image. The discriminator neural network 630 can be trained using training data comprising images of scenes including the volumetric effect so as to classify output images generated by the NST model as being one of fake images generated by the NST model and real images. Based on classification by the discriminator neural network 630, at least one of the generative neural network 620 and the discriminator neural network 630 can be updated.

Generally, the aim of training of the GAN is for the generative neural network 620 to fool the discriminator neural network 630 into classifying an output image generated by the generative neural network 620 as being real data (not generated by the generative neural network 620). Generally, if the discriminator neural network 630 repeatedly classifies the output images as being fake, then the generative neural network 620 should be updated in a way that the discriminator neural network 630 classifies subsequently generated output images as being real data. Subsequent to this, once the output images are sufficiently realistic so as to fool the discriminator neural network 630, then the discriminator neural network 630 should be updated in a way that the discriminator neural network 630 classifies subsequently generated output images as being fake. Training of the generative network and the discriminator network in such an adversarial manner can potentially allow generating of output images with enhanced quality and visual realism.

One benefit to using the GAN is that training data including just scenes with a volumetric effect can be used. Thus, a sufficiently large training data set can be more easily obtained. Moreover, using the GAN can potentially avoid the need for training data comprising images for scenes both with and without volumetric effects. In particular, the generative neural network 620 can be trained in the manner discussed above to attempt to fool discriminator neural network 630, and the discriminator neural network 630 can be trained using or more of: captured images comprising real world scenes including real volumetric effects; and computer-generated images comprising virtual scenes including simulated volumetric effects. More generally, images with highly realistic volumetric effects can be used for training the discriminator such that the discriminator will correctly classify output images from the generative neural network 620 as being fake, until a point at which the generative neural network 620 generates output images that are sufficiently realistic so as to fool the discriminator neural network 630.

Of course, while the content images relate to a virtual scene, training of the discriminator using captured images including real-world scenes may be problematic in that the discriminator may always classify the output images as being fake. In some examples, the captured images may be pre-processed to generate a geometric representation for the real world scene with the volumetric fog. For example, the captured images may be pre-processed to extract information regarding locations and densities of fog, and may also convert the scene to a line black and white line drawing. Similarly output images generated by the generative neural network 620 may be subjected to the same processing prior to being input to the discriminator. Alternatively or in addition, the captured images may be converted to grayscale images for use in training, and similarly output images generated by the generative neural network 620 may be converted to grayscale images prior to being input to the discriminator.

In the case where the training of the discriminator uses computer-generated images comprising virtual scenes including simulated volumetric effects, the computer-generated images may have been subjected to a quality assurance (QA) process whereby one or more real users rate computer-generated images according to a degree of realism, and computer-generated images having at least a threshold rating (i.e. threshold degree of realism as rated by the one or more users) are included in the training data.

In some cases, the rendered image of the second virtual scene and/or the 3D volumetric effect sampling results for the first virtual scene may be pre-processed before input to the NST model. For example, the 3D volumetric effect sampling results may be upscaled as described herein, and/or the rendered image and/or the 3D volumetric effect sampling results may be de-noised.

Referring back to FIG. 4, a step 440 comprises generating, by the NST model, an output image for the second virtual scene using the inputs provided at step 430, i.e. using the image of the second virtual scene as the content image and the 3D volumetric effect sampling results for the first virtual scene as the style image.

The NST model is trained to generate one or more output images in response to one or more content images, using at least one set of 3D sampling results of a volumetric effect (e.g. fog) as a style image. The 3D volumetric effect sampling results may comprise froxel (or voxel) data for representing a volumetric effect in 3D space.

As noted, the image of the second virtual scene rendered at step 420 may be a fog-free image which is then post-processed by inputting the image to the NST model for generating an output image for depicting the virtual environment with fog, in which the NST model uses 3D fog sampling results as the style image. Therefore, an output image including a volumetric effect can be obtained for the second virtual scene without the need for further complex processing operations associated with volumetric rendering.

In the techniques of the present disclosure, output images including a volumetric effect can be output without the need for complex processing operations associated with volumetric rendering for each virtual scene, by re-using sampling results obtained for one virtual scene for one or more further virtual scenes. The above discussion with respect to FIG. 4 refers to inputting 3D volumetric effect (e.g. fog) sampling results for a first virtual scene and an image of a second virtual scene to the NST model. The volumetric effect sampling results and the image may be input to the NST model without being pre-processed or in some cases pre-processing of one or both of these inputs may be performed prior to them being inputted to the NST model. The techniques of the present disclosure allow for integration with existing graphics processing pipelines and allow computationally efficient generation of output images with volumetric effects (e.g. fog effect).

In one or more examples, the image of the second virtual scene (i.e. the ‘content’ image) may be rendered at step 420 without rendering a volumetric effect. For example, the image of the second virtual may be rendered without rendering a volumetric fog effect (so as to render a “fog-free content image”). Hence, the content image may be a fog-free content image. Therefore, rendering operations for rendering a volumetric fog effect, which can be computationally expensive (e.g. due to the use of volumetric rendering approaches), and even more so for cases in which realism and visual quality are of greater importance (such as for rendering of virtual reality content), can be omitted from the rendering operations performed for the second virtual scene. Instead, post-processing using the NST model can be used for obtaining a fog effect in the content image. In this way, the NST model can provide output images for displaying a virtual environment with fog effects with improved computational efficiency and/or visual quality (e.g. visual realism and/or resolution) compared to traditional volumetric rendering techniques.

Alternatively, rendering of the image of the second virtual scene (i.e. the ‘content’ image) at step 420 may comprise one or more volumetric effect rendering operations to render one or more of the content images to include a volumetric (e.g. fog) effect. For example, processing similar to that discussed previously with respect to FIG. 2b may be performed to simulate fog, sample the fog and render a volumetric fog effect. As mentioned previously, rendering of volumetric effects, such as a volumetric fog effect, can be particularly challenging. Moreover, in order to obtain results of a suitable quality (e.g. visual realism and/or resolution) this can potentially include burdensome processing.

Hence, in examples of the disclosure one or more of the rendered content images may include fog, which may be rendered with a low computational budget (e.g. any of a low quality simulation, low quality (e.g. low resolution) sampling and/or low render resolution) to provide a rendered fog which is generally of low quality. One or more such content images can be input to the NST model for style transfer using higher quality 3D sampling results from another virtual scene as the style image. The presence of fog effects within a content image can serve as a guide for the NST model. In particular, the NST model can apply the style transfer to a given content image using the fog effects within that given content image as a guide for the style transfer and thereby generate an output image including fog with improved quality relative to that in the content image.

For example, a content image may be rendered to include fog with a variable density. In particular, the fog in the content image may be patchy with abrupt transitions between regions (or even pixels) of high fog density and low fog density or even no fog. For example, volumetric rendering techniques whereby a simulated fog dataset is sampled to create a 2D or 3D image texture can potentially result in the sampling calculation sampling high density fog for one pixel or voxel or region (e.g. group of pixels or voxels) and sampling no or low density fog for an adjacent pixel, voxel or region. Such a situation may arise from using a low resolution sampling calculation (e.g. a low resolution 3D grid, such as a low resolution froxel grid) to sample a higher resolution 3D fog simulation. This can potentially lead to a flickering effect when viewing a sequence of rendered content images, in that fog may be present at a pixel/region for one image frame and not present at that pixel/region for a next image frame (or fog density may vary greatly for that pixel/region from one image frame to the next image frame). Some volumetric rendering approaches may attempt to overcome this problem by blending sampling results for a number of image frames. For example, for a current image frame, the sampling results may be blended with sampling results from a predetermined number of preceding image frames. In this way, the above mentioned flickering effect may be overcome however this can result in a low quality fog with poor temporal coherence due to smearing of information from multiple earlier image frames.

Hence, in examples of the disclosure, rendering the image at step 420 may comprise rendering a volumetric fog effect. In response to inputting the content image to the NST model, the style transfer can be performed using some of the already present fog for the content image so as to provide a guide for the fog-based style transfer. For example, a content image may be rendered to include a lower density fog in a first portion of the content image and a higher density fog in a second portion of the content image. The NST model can generate an output image comprising a lower density fog in the first portion of the output image and a higher density fog in the second portion of the output image and for which the style transfer results in improved quality (e.g. visual realism and/or resolution) of the fog in the output image. For example, using the 3D fog sample results as the style image, the output image may be generated so that a transition between the lower density fog and the higher density fog in the output image has improved quality relative to the content image (e.g. a more gradual and realistic transition of fog density).

More generally, by rendering one or more content images to include fog effects, the fog already present in a content image may serve as a guide for the style transfer by the NST model when using the 3D fog sampling results as the style image. For example, the location and/or density of fog in a content image can assist in controlling the style transfer to control location and/or density of fog for the output image.

For clarity of explanation, the description herein primarily refers to an example in which a single set of 3D sampling results is obtained at step 410, a single image is rendered at step 420, and a single output image is generated at steps 430-440. However, it will be appreciated that the method 400 may be used to generate a plurality of output images using the NST model based on a plurality of sets of sampling results and/or a plurality of rendered images. For example, a plurality of sets of 3D fog sample results may be input as style images for one content image (e.g. for use for different parts thereof) so that the style of each of the sets of fog sample results is transferred onto the rendered content image, optionally with a weighting applied to each set of sampling results to dictate its relative contribution to the style transfer process.

Alternatively, or in addition, a plurality of output images may be generated by the NST model based on the same 3D fog sampling results and one rendered image. For instance, each output image may be a different variant of the rendered image that assigns a different priority to maintaining the content of the rendered image and transferring the style from the 3D fog sampling results (e.g. by assigning different weightings to the content and style loss functions).

Alternatively, or in addition, a plurality of content images may be rendered at step 420, with each content image being processed using style transfer to incorporate and/or improve a volumetric effect in the content image.

The above discussion refers to the possibility of the images rendered at step 420 including a volumetric fog effect. For clarity of explanation, the following discussion will generally refer to arrangements in which the content images rendered at step 420 are fog-free (or more generally volumetric effect free). However, it will be understood that references in the following discussion to rendered content images may refer to any of content images that are fog-free (i.e. rendered without rendering a fog effect) and content images that include fog.

In some examples, a sequence of content images of virtual scenes may be rendered with each content image intended to include fog effects and the NST model may use a same 3D fog sampling results as the style image for the sequence of output images. In this way, the output images may depict the virtual environment with an animated fog (e.g. a fog animation may be visually depicted in the sequence) whilst potentially using a single set of 3D sampling results depicting a same (static) fog as the style image.

In such examples, step 440 may comprise generating a sequence of output images in response to an input sequence of content rendered images, each output image corresponding to a respective content image. The sequence of content images may be rendered at any suitable frame rate (e.g. N Hz). Each rendered image may be input to NST model as a content image for generating a corresponding output image. In this way, output images may be generated at a same frame rate (e.g. N Hz). Hence, rendered content images can be post-processed in real-time to obtain output images including a volumetric effect associated with the 3D volumetric effect sampling results which are used as the style image.

In some cases, the NST model may generate each output image of a sequence of output images using a same set of 3D sampling results for a (first) virtual scene. For example, a single set of 3D fog sampling results may be used by the NST model for post-processing a plurality of rendered content images to generate a plurality of output images. Put differently, a plurality of content images corresponding to a period of time (e.g. of the order of seconds or even minutes) may be input to the NST model and each post-processed using a same respective set of 3D fog sample results to obtain a sequence of output images styled based on the same respective fog sample results.

Animation of fog between the output images may be achieved in several different ways. As noted, animation of the fog between the output images may be achieved by rendering a lower quality fog effect when rendering the images at step 420 so as to guide the subsequent style transfer from higher quality 3D sampling results.

Alternatively, or in addition, a time-varying control signal may be input to the NST model for animation of a volumetric effect depicted in the sequence of output images. For example, a same set of 3D fog sampling results may be used as a style image for multiple content images and the time-varying control signal may be used for allowing animation of fog depicted in the sequence of output images.

The time-varying control signal may be used by the NST model to achieve animation of the volumetric effect in the output images in a number of ways. The time-varying control signal may be used together with 3D fog sampling results. Hence a location and/or density of fog in the output images may be controlled responsive to the time-varying control signal. In some cases, the time-varying control signal may be used to apply animation to a respective 3D fog sampling results. The varying control signal may be used to apply updates to location and/or densities for fog in the respective 3D fog sampling results and updated versions of the fog sampling results may be used as the style image by the NST model.

Alternatively, or in addition, a sequence of sets of 3D volumetric effect (e.g. fog) sampling results depicting an animation of the volumetric effect may be input to the NST model. For example, 3D volumetric effect sampling results may be obtained for a plurality of frames of content (e.g. from a first videogame) and stored as a sequence of animated 3D sampling results, for use in re-creating the animation in images to which style is transferred from the 3D sampling results. Using the input sequence of sets of 3D volumetric effect sampling results and the plurality of content images as inputs, the NST model may generate the sequence of output images. Hence, both a sequence of content images and a sequence of 3D volumetric effect sampling results may be input to the NST model. A frame rate associated with the sequence of content images may be the same as or different from a frame rate associated with the sequence of 3D volumetric effect sampling results. In some examples, the two frame rates may be the same such that there is a 1:1 correspondence between content rendered images and 3D volumetric effect sampling results. Put differently, for each of the rendered content images, a different set of 3D volumetric sampling results may be used by the NST model as the style image. In some examples, the two frame rates may be different. For example, the frame rate associated with the content images may be N Hz and the frame rate associated with the sets of 3D volumetric effect sampling results may be M Hz, where M is smaller than N. For example, the content images may have a frame rate of 60 Hz and the sets of 3D volumetric effects sampling results may have a frame rate of 30 Hz such that a same set of 3D volumetric effect sampling results is used for two successive content images (i.e. a 1:2 correspondence).

In some cases, inputting of a given rendered image as a content image and a 3D volumetric effect sampling results as a style image to the NST model may potentially result in style transfer with reduced levels of control over the location and/or density of the volumetric effect in the resulting output image. For example, for a rendered content image depicting a first type of scene (e.g. forest scene) and 3D volumetric effect sampling results from a simulation of a second type of scene (e.g. beach scene) with fog, the style transfer may result in an output image with unrealistic fog effects. The techniques of the present disclosure provide a number of possibilities for improving control for a volumetric effect in the output images. In particular, the techniques of the present disclosure provide a number of possibilities for improving control for a volumetric fog effect.

As explained previously, in some examples, the content image may be rendered to include volumetric fog (e.g. low quality volumetric fog). The fog effect present in a given content image may serve as a guide for the style transfer by the NST model. For example, fog already present in a given content image can be used to control a location and/or density for the style transfer, whilst the style image includes fog with visual realism so as to assist in achieving fog with visual realism for those locations in the output image. In some cases, the content image may be rendered to include volumetric fog only in part thereof, to reduce computational costs. For example, fog may be rendered in the vicinity (e.g. within a predetermined distance of) objects in the virtual environment to guide the style transfer of fog in those areas where the quality of fog is most noticeable to end users.

Alternatively or in addition, the 3D volumetric effect sampling results (to be used as the style image) may be selected from amongst a plurality of sets of 3D volumetric effect sampling results for a plurality of virtual scenes. The selection of the 3D volumetric effect sampling results may be made in dependence on one or more properties of the rendered image of the second virtual scene. A plurality of candidate sets of 3D fog sampling results may be available for selection; for example, each set of 3D fog sampling results may be obtained for different virtual scenes. In this way, for a given rendered content image, 3D fog sampling results that are best suited to the content image for being used as a style image by the NST model can be advantageously selected.

The properties of the rendered content image used for selecting the 3D fog sampling results may comprise one or more of: a type of the second virtual scene (i.e. scene type), one or more properties of one or more light source(s) in the second virtual scene (e.g. the types and numbers of the light sources), and/or image brightness.

The scene type may for example comprise a classification of the second virtual scene based on one or more objects in the second virtual scene. Different scene types may for example include a forest scene, mountain scene, beach scene, urban scene, meadow scene and so on. It will be appreciated that a broader or narrower classification of scene type may be implemented as desired.

The image properties may for example be detected using one or more of pixel value analysis and computer vision techniques. For example, analysis of pixel values may be used to detect an image brightness for a content image. Computer vision techniques may be used to detect objects (e.g. object types) included in a content image and/or a classify a content image based on scene type. Hence more generally, a content image may be analysed to detect at least one property for the content image and on this basis a selection of at least one set of 3D fog sampling results for use as a style image can be performed so that the NST model uses a fog sampling results that are suitable for the at least one property.

The properties of the content image may be determined in several ways. For example, a scene classifier model may be used to classify a scene in the content image into one or more scene types. Alternatively or in addition, an object recognition model may be used for detecting object types in the content image. The scene classifier model and object recognition model may use known machine learning (e.g. computer vision) techniques for such detection. Alternatively or in addition, pixel values of the content image may be analysed to calculate an image brightness for the content image and/or to classify the content image according to an image brightness classification from a plurality of image brightness classifications. For example, a scalar value indicative of an image brightness may be calculated for a content image based on analysis of pixel values, and/or an image brightness classification (e.g. high image brightness, medium image brightness, low image brightness) may be determined for the content image. It will be appreciated that any suitable number of image brightness classifications may be used in this way.

Generally, the inventors have found that appearance of fog is likely to differ for different types of scenes, different types of light sources (e.g. whether a scene is under sunlight, moonlight, streetlights, shaded etc.) and/or different image brightness. Therefore, in some examples, the 3D fog sampling results to be used as a style image by the NST model may be selected in dependence upon detection of at least one of a scene type, a light source type and an image brightness associated with a respective content image used by the NST model. In this way, 3D fog sampling results that are suited to one or more of the scene type, light source type and image brightness of the content image can be selected. Therefore, an appearance of the fog effect represented by the selected 3D fog sampling results can be suited to an appearance of fog effect used for the content image.

Moreover, in some cases neural style transfer using a style image having first properties (e.g. a first scene type) and a content image having second properties (e.g. a second scene type) can potentially result in visual artefacts in the resulting output image. This may arise from parts of a scene in the style transfer image being transferred erroneously. By using a style image and a content image having matching properties, the presence of such visual artefacts can be at least partly reduced or removed for the resulting output image.

The selection of 3D fog sampling results based on properties of the rendered image may be performed based on predetermined descriptors of (i.e. metadata for) each set of 3D fog sampling results. For example, when generating given 3D fog sampling results for a given virtual scene, properties of a rendered display image of the given virtual scene may be stored as descriptors for the given 3D fog sampling results. 3D fog sampling results whose corresponding display images have properties that are most closely aligned with the properties of the rendered content image may then be selected for use as a style image. The alignment of image properties between the display images and the content images may be determined based on an empirically determined function. In other words, when generating the 3D fog sampling results for various ‘first’ virtual scenes, display images of the first virtual scenes may be rendered and their properties determined, for future comparison with properties of rendered content images. Alternatively, one or more predetermined descriptors for the 3D fog sampling results may be obtained without rendering corresponding display images, e.g. a scene type for the first virtual scene may be obtained from game metadata.

The plurality of candidate 3D fog sampling results may be generated in advance and each labelled with metadata/descriptors indicative of a scene type, one or more light source types and/or an image brightness (e.g. image brightness classification), e.g. as obtained by analysing display images of the virtual scenes for which 3D fog sampling results were generated. Hence, in response to detection of one or more properties for a given content image, a look-up can be performed with respect to the plurality of candidate 3D fog sampling results to select a set of 3D sampling results.

At least some of the plurality of candidate 3D fog sampling results may each be associated with at least one of a different scene type, a different light source properties and a different image brightness. Fog simulations may be performed for different scene types, light sources, and/or image brightness (e.g. using a game engine such as the Unreal® game engine) and sampled to obtain the candidate sets of 3D fog sampling results.

Considering different light source properties, for example, candidate 3D fog sampling results may be associated with virtual scenes having different numbers and/or types of light sources. For instance, first candidate 3D fog sampling results may be for a virtual scene having a light source type such as the sun, while second candidate 3D fog sampling results may be for a virtual scene having a light source type such as the moon or a street light. For example, in the case of grayscale values ranging from 0-255 with 0 corresponding to black and 255 corresponding to white, for a same virtual scene (e.g. an urban scene), a sunlit fog can be expected to have pixel values indicative of higher grayscale values whereas a moonlit fog can be expected to have pixel values indicative of lower grayscale values. More generally, appearance of fog can be expected to differ for different types and numbers of light sources. In a similar manner candidate 3D fog sampling results may be associated with virtual scenes of different image brightness (as determined by analysing a display image of the virtual scene).

Alternatively or in addition, in some embodiments of the disclosure at least some of the plurality of candidate 3D fog sampling results may be associated with a different fog density (i.e. fog thickness, or fog visibility). Similar to what has been discussed above, metadata associated with a candidate set of 3D fog sampling results may be indicative of a fog visibility associated with that set of samples (e.g. a fog visibility classification from a plurality of different fog visibility classifications).

The plurality of candidate sets of 3D fog sampling results may comprise a first set of 3D fog sampling results associated with a first fog visibility and a second set of 3D fog sampling results associated with a second fog visibility different from the first fog visibility. More generally, the plurality of candidate sets of 3D fog sampling results may comprise a plurality of respective sets of 3D fog sampling results associated with a plurality of different fog visibilities. A lower fog visibility is characterised by thicker (i.e. denser) fog, whereas a higher fog visibility is characterised by thinner (i.e. less dense) fog. The sets of 3D fog sampling results may have froxel (or voxel) values for specifying colour and transparency (e.g. RGBA values indicative of red, green, blue and alpha values), in which a set of 3D fog sampling results associated with a lower fog visibility has a lower transparency (e.g. larger alpha (A) values for the froxels) and a set of 3D fog sampling results associated with a higher fog visibility has a higher transparency (e.g. smaller alpha (A) values for the froxels).

Therefore, the set of 3D fog sampling results for use a style image by the NST model may be selected in dependence on a target fog density (i.e. target fog visibility) for the content image. The target fog visibility may be specified by an interactive application (e.g. game application) or game engine. For example, a game engine may generate a signal indicative of a target fog visibility for one or more content images. Alternatively, or in addition, the target fog visibility may be received from a user input.

Selection of a set of 3D fog sampling results in dependence upon a target fog visibility may be performed in a number of ways. The target fog visibility may be defined as a transparency value (e.g. an alpha value between 0 and 1), for allowing selection with respect to the candidate sets of 3D fog sampling results. A comparison of a target transparency value and transparency values associated with each of a plurality of candidate sets of 3D fog sampling results may be performed to select a set of 3D fog sampling results. For example, an average (e.g. mean, mode or median) transparency value for each of a plurality of candidate sets of 3D fog sampling results may be compared with the target transparency value to select a set of 3D fog sampling results having a smallest difference with respect to the target transparency value.

Alternatively or in addition, at least some of the candidate sets of 3D fog sampling results may be assigned a visibility level from a predetermined number of visibility levels (e.g. high visibility, medium visibility, low visibility). Similarly, the target fog visibility may be defined as a respective visibility level. Hence, a set of 3D fog sampling results may be selected having a same (or closest) visibility level as the target fog visibility.

In some cases, the target fog visibility may be defined in terms of a visibility distance in a virtual environment (e.g. a depth at which a scene is to be fully obscured by the fog). In some examples, a conversion between visibility distance in a virtual environment and alpha values or a visibility level may be used to convert the target fog visibility to an alpha value or a visibility level which can then be used for the selection according to the techniques discussed above.

Hence more generally, the set of 3D sampling results for use as a style image may be selected in dependence upon a target fog visibility. In this way, a fog visibility for the output image can be more precisely controlled.

A sequence of content images may be rendered at step 420 (having any suitable frame rate), and a fog visibility for the resulting output images can be varied by varying the 3D fog sampling results used as the style image, so that output images with a first fog visibility can be generated during a first period of time and output images with a second fog visibility can be generated during a second period of time. For example, a user may move a virtual entity (e.g. virtual avatar) within a virtual environment to approach and enter a fog and a sets of 3D fog sampling results to be used as a style image can be varied in response to changes in the target fog visibility (e.g. requested by a game engine and/or the rendering circuitry 310).

The above discussion refers to arrangements in which a style image used by the NST model can be controlled accordingly for one or more content images.

Alternatively or in addition, in some examples, the method 400 may comprise selecting an NST model from a plurality of NST models, each of the plurality of NST models having been trained for style transfer for content images with different properties (e.g. at least one of a different scene type, a different light source type and a different image brightness). For example, a first NST model may have been trained for a first type of scene (e.g. a forest scene) and a second NST model may have been trained for a second type of scene (e.g. an urban scene). The scene type for a content image may be detected, and in response the content image may be input to a given NST model selected from the plurality of NST models, in which the given NST model has been trained for that scene type. In a similar manner, detection of light source type (e.g. detection of an object such as a virtual lamp, virtual sun or virtual moon) and/or detection of image brightness for a content image may be used for selection of an NST model.

Each of the plurality of NST models may be trained using training data corresponding to given image properties (e.g. training data for a given scene type). For example, an initial training dataset may be classified into a plurality of sub-datasets each relating to different image properties for use in training the different NST models.

In an example, the 3D volumetric effect sampling results used for style transfer by the NST model may be generated in real-time. This removes the need to pre-generate sampling results and allows applying the present techniques to a wider range of content.

For instance, when generating output images for a sequence of virtual scenes (e.g. corresponding to a sequence of frames for content), 3D volumetric effect sampling results may be obtained for a subset of the virtual scenes and used then to obtain volumetric effects in the other virtual scenes via style transfer using the NST model. In this way, output images including volumetric effects can be generated more efficiently by re-using volumetric effect sampling results between virtual scenes. This example is further illustrated in FIGS. 7 and 8.

Referring to FIG. 7, a sequence of output images of virtual scenes 53-61 for content (e.g. for a videogame) is shown.

3D fog sampling results may be obtained for virtual scenes 54, 58, and 61. These 3D fog sampling results may be used to obtain fog effects in virtual scenes 55-57 by using the 3D fog sampling results for virtual scene 54 as the style image, and to obtain fog effects in virtual scenes 59-60 by using the 3D fog sampling results for virtual scene 58 as the style image. Animation of the fog between virtual scenes 54-61 may be generated using one or more of the techniques described herein (e.g. using a time-varying signal input to the NST model).

As discussed in further detail in relation to FIG. 8, one or more predetermined conditions may be evaluated when generating each output image to determine whether 3D fog sampling results from a previous virtual scene can be re-used to generate the output image for the current virtual scene. In the example of FIG. 7, for virtual scenes 55-57 the predetermined conditions are satisfied, and the 3D fog sampling results for virtual scene 54 are re-used in generating output images for virtual scenes 55-57. However, for virtual scene 58 the predetermined conditions are not satisfied, and 3D fog sampling results are obtained anew for virtual scene 58 (e.g. the fog is simulated and sampled using a 3D grid for virtual scene 58). Subsequently, the predetermined conditions are satisfied for virtual scenes 59 and 60, and the 3D fog sampling results for virtual scene 58 are re-used in generating output images for virtual scenes 59-60. For virtual scene 61, the predetermined conditions are once more not satisfied, and 3D fog sampling results are obtained for virtual scene 61. The process may continue in this way for any number of virtual scenes.

In the example of FIG. 7, for a given virtual scene (e.g. virtual scene 59), the 3D fog sampling results that are available for a most recent virtual scene (e.g. virtual scene 58) are used in the style transfer. However, it will be appreciated that any other available 3D fog sampling results from a previous virtual scene may be used instead. For example, the most suitable 3D fog sampling results may be selected based on properties of the rendered image of a virtual scene, as described elsewhere herein. For instance, previously obtained 3D fog sampling results for a previous virtual scene of a type that is a closest match for the current virtual scene may be selected.

Referring to FIG. 8, a further example image processing method in accordance with embodiments of the disclosure is shown. Virtual scenes A, B, and C referred to in FIG. 8 may form part of a sequence of virtual scenes for content, as shown e.g. in FIG. 7.

A step 810 comprises obtaining 3D fog sampling results from a simulation of a volumetric effect for virtual scene A. The 3D fog sampling results for virtual scene A may be obtained using the techniques described in relation to step 410 of method 400.

A step 815 comprises rendering an image of virtual scene B. The image of virtual scene B may be rendered using the techniques described in relation to step 420 of method 400.

A step 820 comprises evaluating one or more predetermined conditions to determine whether the 3D fog sampling results for virtual scene A can be re-used as a style image, in combination with the rendered image of scene B as a content image, for generating an output image including fog for virtual scene B. The predetermined conditions provide an indication as to the suitability of the 3D fog sampling results for virtual scene A for use as a style image for generating an output image of virtual scene B.

The predetermined conditions may for example relate to relative positions of the first and second virtual scenes in a sequence of virtual scenes, and/or to one or more properties of the rendered image of scene B. For example, a predetermined condition may relate to a threshold number (e.g. N) of virtual scenes in-between the first and second virtual scenes. For this predetermined condition to be satisfied, the number of virtual scenes between the first and second virtual scenes needs to be below the threshold. In this way, 3D fog sampling results may in effect be obtained every N virtual scenes.

Alternatively, or in addition, one or more predetermined conditions may be evaluated in dependence on properties of the rendered image of virtual scene B rendered at step 815. These predetermined conditions may indicate whether the 3D fog sampling results for virtual scene A are well suited for use as a style image for a content image having the properties of the rendered image of virtual scene B. Such predetermined conditions may for example be evaluated in a similar way to how 3D fog sampling results may be selected based on properties of the rendered image as described elsewhere herein. For example, a predetermined condition may be satisfied if the rendered image and the 3D fog sampling results correspond to scenes of the same scene type.

Alternatively, or in addition, a predetermined condition may relate to a threshold time period between obtaining samples for virtual scenes when generating images for content. For instance, samples for the current virtual scene may be re-obtained every N (e.g. 1, 3, 5) seconds.

In response to (i.e. in dependence on) the predetermined conditions being satisfied, the method proceeds to step 830.

A step 830 comprises generating an image of virtual scene B by the NST model using the rendered image of virtual scene B as a content image, and the 3D fog sampling results for virtual scene A as a style image. That is, in response to the predetermined conditions being met (e.g. the image brightness of the image of scene A being the same or within predetermined threshold of an image brightness associated with the 3D fog sampling results for scene B), the output image for scene B including fog is generated using style transfer from the 3D fog sampling results for scene A. This allows improving the efficiency of generating images including fog by re-using sampling results from a previous scene (e.g. scene A) for one or more subsequent scenes (e.g. scene B). At the same time, making step 830 conditional on the one or more predetermined conditions being satisfied ensures that the sampling results to be re-used are appropriate for the current scene. The style transfer at step 830 may be performed using the techniques described above with reference to steps 430-440 of method 400.

In response to the predetermined conditions not being satisfied, the method proceeds to step 835.

A step 835 comprises obtaining 3D fog sampling results from a simulation of a volumetric effect for virtual scene B. The 3D fog sampling results for virtual scene B may be obtained using the techniques described in relation to step 410 of method 400.

With regards to generating an output image for scene B including fog, several options are available. For example, the image of scene B may be re-rendered using the obtained 3D fog sampling results for scene B, e.g. using the rendering pipeline described herein. In this way, an image for scene B with ‘simulated’ fog may be generated.

Alternatively, an output image for scene B may be generated by the NST model using the image of scene B rendered at step 815 (e.g. a fog-free image of scene B) as a content image and the 3D fog sampling results for scene B as a style image. This approach may appear counterintuitive, but it advantageously allows maintaining a more consistent appearance of output images by generating each output image using style transfer, as opposed to having some output images including ‘simulated fog’ as per the preceding option. In this way, generation of fog in the images via style transfer is less noticeable to the user.

Alternatively, an output image for scene B may not be generated at all. For example, an output image frame associated with scene B may be omitted from output content. Again, this allows avoiding outputting some images with simulated fog, and some images with style-transferred fog, which may otherwise result in changing appearance of the fog, and increased noticeability of the use of style transfer for some output images.

Steps 840 and 850 relate to generation of output images for subsequent virtual scenes in the sequence of virtual scenes, now using the more recent 3D fog sampling results obtained for scene B.

A step 840 comprises rendering an image of virtual scene C. The image of virtual scene C may be rendered using the techniques described in relation to step 420 of method 400.

A step 850 comprises generating an image of virtual scene C by the NST model using the rendered image of virtual scene C as a content image, and the 3D fog sampling results for virtual scene B as a style image. In this way, more recent 3D fog sampling results are used a style image, providing improved quality of the fog in the output image.

It will be appreciated that, like step 830, step 850 may be conditional on the one or more predetermined conditions being satisfied. In other words, every step of generating output images using the NST model based on 3D fog sampling results for a previous virtual scene may be conditional on the predetermined conditions being satisfied. This allows improving the quality of the fog in the output images.

It will also be appreciated that one or more of the above described techniques for animation of the fog between output images may be used with the method of FIG. 8. For instance, a time-varying signal may be input to the NST model to animate the fog between output images for virtual scenes B and C.

Referring back to FIG. 4, an image processing method 400 for generating images including a volumetric effect comprises the following steps.

A step 410 comprises obtaining three-dimensional “3D” volumetric effect sampling results from a simulation of a volumetric effect for a first virtual scene, as described elsewhere herein.

A step 420 comprises rendering an image of a second virtual scene, as described elsewhere herein.

A step 430 comprises inputting the 3D volumetric effect sampling results for the first virtual scene, and the rendered image of the second virtual scene to a neural style transfer “NST” model trained to generate an output image in dependence on a style image and a content image, as described elsewhere herein.

A step 440 comprises generating, by the NST model, an output image for the second virtual scene using the rendered image of the second virtual scene as the content image and the 3D volumetric effect sampling results for the first virtual scene as the style image, as described elsewhere herein.

It will be apparent to a person skilled in the art that variations in the above method corresponding to operation of the various embodiments of the method and/or apparatus as described and claimed herein are considered within the scope of the present disclosure, including but not limited to that:
the 3D volumetric effect sampling results for the first virtual scene comprise volumetric effect data sampled using a frustrum voxel grid, as described elsewhere herein;
the method further comprises, prior to inputting 430 the 3D volumetric effect sampling results to the NST model, upscaling the 3D volumetric effect sampling results to increase their sampling resolution, as described elsewhere herein;
   where, optionally, the upscaling is performed using bicubic interpolation, as described elsewhere herein;
   where, optionally, the upscaling is performed using a machine learning model trained to upscale at least part of input 3D sampling results, as described elsewhere herein;
      where, optionally, the machine learning model comprises one or more from the list consisting of: a recurrent neural network (RNN), and an attention enhanced super-resolution GAN model (A-ESRGAN), as described elsewhere herein;
rendering 420 the image of the second virtual scene comprises at least partially rendering a volumetric effect using second 3D volumetric effect sampling results from a simulation of the volumetric effect for at least part of the second virtual scene, wherein the second 3D volumetric effect sampling results are of lower quality than the 3D volumetric effect sampling results obtained for the first virtual scene, as described elsewhere herein;
   where, optionally, the second 3D volumetric effect sampling results have a lower sampling resolution than the 3D volumetric effect sampling results obtained for the first virtual scene, as described elsewhere herein;
   where, optionally, the at least part of the second virtual scene comprises one or more parts of the virtual scene within a predetermined distance of objects in the virtual scene, as described elsewhere herein;
the first virtual scene and the second virtual scene are part of a sequence of virtual scenes for content, as described elsewhere herein;
the step of generating 440, by the NST model, the output image for the second virtual scene using the 3D volumetric effect sampling results for the first virtual scene as the style image is performed in dependence on one or more predetermined conditions being satisfied, as described elsewhere herein;
   where, optionally, the method further comprising, in response to the one or more predetermined conditions not being satisfied: obtaining 3D volumetric effect sampling results from a simulation of a volumetric effect for the second virtual scene, as described elsewhere herein;
      where, optionally, the method further comprising, in response to the one or more predetermined conditions not being satisfied: generating, by the NST model, an output image for the second virtual scene using the rendered image for the second virtual scene as a content image and the 3D volumetric effect sampling results for the second virtual scene as a style image, as described elsewhere herein;
      where, optionally, the method further comprising, in response to the one or more predetermined conditions not being satisfied, rendering an output image for the second virtual scene using 3D volumetric effect sampling results for the second virtual scene, as described elsewhere herein;
   where, optionally, the method further comprising: rendering an image of a third virtual scene, the third virtual scene being part of the sequence of virtual scenes for content; inputting the 3D volumetric effect sampling results for the second virtual scene, and the rendered image of the third virtual scene to the NST model; and generating, by the NST model, an output image for the third virtual scene using the rendered image of the third virtual scene as the content image and the 3D volumetric effect sampling results for the second virtual scene as the style image, as described elsewhere herein;
   where, optionally, the one or more predetermined conditions relate to one or more from the list consisting of: positions of the first and second virtual scenes in the sequence of virtual scenes for content, and one or more properties of the rendered image of the second virtual scene, as described elsewhere herein;
      where, optionally, the one or more properties of the rendered image comprise one or more selected from the list consisting of: a type of the second virtual scene, one or more properties of one or more light sources in the second virtual scene, and image brightness, as described elsewhere herein;
the volumetric effect comprises a volumetric fog effect; and wherein the method further comprises: receiving a target fog density for the volumetric fog effect, and selecting the 3D volumetric effect sampling results, for use as the style image, from amongst a plurality of candidate sets of 3D volumetric effect sampling results for a plurality of virtual scenes, in dependence on the target fog density, as described elsewhere herein;
   where, optionally, the candidate sets of 3D volumetric effect sampling results are associated with a plurality of different fog densities, as described elsewhere herein;
the method further comprising selecting the 3D volumetric effect sampling results, for use as the style image, from amongst a plurality of candidate sets of 3D volumetric effect sampling results for a plurality of virtual scenes, in dependence on one or more properties of the rendered image of the second virtual scene, as described elsewhere herein;
   where, optionally, the one or more properties of the rendered image comprise one or more selected from the list consisting of: a type of the second virtual scene, one or more properties of one or more light sources in the second virtual scene, and image brightness, as described elsewhere herein;
the method further comprising selecting the NST model from amongst a plurality of NST models in dependence on one or more properties of the rendered image of the second virtual scene, each of the plurality of NST models having been trained for style transfer for content images with different properties, as described elsewhere herein;
   where, optionally, the one or more properties of the rendered image comprise one or more selected from the list consisting of: a type of the second virtual scene, one or more properties of one or more light sources in the second virtual scene, and image brightness, as described elsewhere herein;
rendering 420 an image of a second virtual scene comprises rendering a sequence of images of virtual scenes for content; and wherein generating the output image comprises generating, by the NST model, a sequence of output images using the sequence of rendered images as content images, each output image corresponding to a respective rendered image, as described elsewhere herein;
   where, optionally, generating 440, by the NST model, the sequence of output images comprises using the same 3D volumetric effect sampling results as the style image for each rendered image; the method further comprising inputting a time-varying control signal to the NST model for animation of the volumetric effect depicted in the sequence of output images, as described elsewhere herein;
   where, optionally, the method further comprising obtaining a sequence of 3D volumetric effect sampling results depicting a volumetric effect animation; wherein generating the sequence of output images comprises using respective 3D volumetric effect sampling results as style images for respective rendered images, as described elsewhere herein;
the NST model comprises one or more 3D convolutional neural networks, as described elsewhere herein;
the NST model comprises a generative neural network trained to generate an output image using a content image and 3D volumetric effect sampling results as the style image, as described elsewhere herein;
   where, optionally, the NST model comprises a generative adversarial network “GAN” comprising the generative neural network and a discriminator neural network trained using training data comprising images of scenes including a volumetric effect so as to classify output images generated by the NST model as being one of fake images generated by the NST model and real images, as described elsewhere herein;
      where, optionally, wherein the discriminator neural network has been trained using one or more of: captured images comprising real world scenes including real volumetric effects; and computer-generated images comprising virtual scenes including simulated volumetric effects, as described elsewhere herein;
obtaining 310 the 3D volumetric effect sampling results for the first virtual scene comprises sampling, using a 3D grid, volumetric effect data from the simulation of the volumetric effect for the first virtual scene, as described elsewhere herein;
   where, optionally, obtaining 310 the 3D volumetric effect sampling results further comprises simulating the volumetric effect for the first virtual scene to obtain the volumetric effect data, as described elsewhere herein;
   where, optionally, the 3D grid is a froxel grid, as described elsewhere herein;
the volumetric effect comprises one or more from the list consisting of: a volumetric fog effect; a volumetric smoke effect; a volumetric water effect; a volumetric fire effect; and a volumetric mobile particles effect, as described elsewhere herein;
rendering 420 the image of the second virtual scene comprises rendering a 2D image of the second virtual scene, as described elsewhere herein;
rendering 420 the image of the second virtual scene comprises rendering a 3D volumetric image of the second virtual scene, as described elsewhere herein;
the method further comprises evaluating one or more predetermined conditions in dependence on one or more properties of the first and second virtual scenes; wherein the step of generating the output image for the second virtual scene by the NST model using the 3D volumetric effect sampling results for the first virtual scene as the style image is performed in response to the one or more predetermined conditions being met, as described elsewhere herein;
the method further comprises outputting the output image for display at a display device, as described elsewhere herein;
the 3D volumetric effect sampling results for the first virtual scene comprise volumetric effect data sampled using a voxel grid, as described elsewhere herein;
the method further comprises outputting the generated display images to a display device, as described elsewhere herein;
the method is computer-implemented, as described elsewhere herein; and
the and/or each virtual scene is a virtual scene for a videogame, as described elsewhere herein.

In certain implementations, there is provided a method of training a machine learning model for use in image processing, as described elsewhere herein. In some implementations, there is provided a trained machine learning model for use in image processing, as described elsewhere herein.

It will be appreciated that the above methods may be carried out on conventional hardware suitably adapted as applicable by software instruction or by the inclusion or substitution of dedicated hardware.

Thus the adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Referring back to FIG. 3, an image processing system 300 for generating images including a volumetric effect may comprise the following:

A sampling processor 310 configured (for example by suitable software instruction) to obtain 3D volumetric effect sampling results from a simulation of a volumetric effect for a first virtual scene, as described elsewhere herein. A rendering processor 320 configured (for example by suitable software instruction) to render an image of a second virtual scene, as described elsewhere herein. An NST model 330 trained to generate an output image in dependence on a style image and a content image. The NST model may be configured (for example by suitable software instruction) to receive the 3D volumetric effect sampling results for the first virtual scene, and the rendered image of the second virtual scene as inputs, and generate an output image for the second virtual scene using the rendered image of the second virtual scene as the content image and the 3D volumetric effect sampling results for the first virtual scene as the style image, as described elsewhere herein.

It will be appreciated that the above system 300, operating under suitable software instruction, may implement the methods and techniques described herein.

Of course, the functionality of these processors may be realised by any suitable number of processors located at any suitable number of devices and any suitable number of devices as appropriate rather than requiring a one-to-one mapping between the functionality and a device or processor.

The foregoing discussion discloses and describes merely exemplary embodiments of the disclosed technology. As will be understood by those skilled in the art, the technology may be embodied in other specific forms without departing from the spirit or essential characteristics thereof. Accordingly, the disclosure is intended to be illustrative, but not limiting of the scope, as well as other claims. The disclosure, including any readily discernible variants of the teachings herein, defines, in part, the scope of the foregoing claim terminology such that no inventive subject matter is dedicated to the public.

1. An image processing method for generating images including a volumetric effect, the method comprising:
obtaining three-dimensional “3D” volumetric effect sampling results from a simulation of a volumetric effect for a first virtual scene;
rendering an image of a second virtual scene;
inputting the 3D volumetric effect sampling results for the first virtual scene, and the rendered image of the second virtual scene to a neural style transfer “NST” model trained to generate an output image in dependence on a style image and a content image; and
generating, by the NST model, an output image for the second virtual scene using the rendered image of the second virtual scene as the content image and the 3D volumetric effect sampling results for the first virtual scene as the style image.

2. The image processing method of claim 1, wherein the 3D volumetric effect sampling results for the first virtual scene comprise volumetric effect data sampled using a frustrum voxel grid.

3. The image processing method of claim 1, further comprising, prior to inputting the 3D volumetric effect sampling results to the NST model, upscaling the 3D volumetric effect sampling results to increase their sampling resolution.

4. The image processing method of claim 1, wherein rendering the image of the second virtual scene comprises:
at least partially rendering a volumetric effect using second 3D volumetric effect sampling results from a simulation of the volumetric effect for at least part of the second virtual scene, wherein the second 3D volumetric effect sampling results are of lower quality than the 3D volumetric effect sampling results obtained for the first virtual scene.

5. The image processing method of claim 1, wherein the first virtual scene and the second virtual scene are part of a sequence of virtual scenes for content.

6. The image processing method of claim 5, wherein the step of generating, by the NST model, the output image for the second virtual scene using the 3D volumetric effect sampling results for the first virtual scene as the style image is performed in dependence on one or more predetermined conditions being satisfied.

7. The image processing method of 6, further comprising, in response to the one or more predetermined conditions not being satisfied:
obtaining 3D volumetric effect sampling results from a simulation of a volumetric effect for the second virtual scene; and
generating, by the NST model, an output image for the second virtual scene using the rendered image for the second virtual scene as a content image and the 3D volumetric effect sampling results for the second virtual scene as a style image.

8. The image processing method of claim 6, wherein the one or more predetermined conditions relate to one or more from the list consisting of:
positions of the first and second virtual scenes in the sequence of virtual scenes for content, and one or more properties of the rendered image of the second virtual scene.

9. The image processing method of claim 1, wherein the volumetric effect comprises a volumetric fog effect; and wherein the method further comprises:
receiving a target fog density for the volumetric fog effect, and
selecting the 3D volumetric effect sampling results, for use as the style image, from amongst a plurality of candidate sets of 3D volumetric effect sampling results for a plurality of virtual scenes, in dependence on the target fog density.

10. The image processing method of claim 1, further comprising:
selecting the 3D volumetric effect sampling results, for use as the style image, from amongst a plurality of candidate sets of 3D volumetric effect sampling results for a plurality of virtual scenes, in dependence on one or more properties of the rendered image of the second virtual scene; wherein the one or more properties of the rendered image comprise one or more selected from the list consisting of: a type of the second virtual scene, one or more properties of one or more light sources in the second virtual scene, and image brightness.

11. The image processing method of claim 1, further comprising:
selecting the NST model from amongst a plurality of NST models in dependence on one or more properties of the rendered image of the second virtual scene, each of the plurality of NST models having been trained for style transfer for content images with different properties; wherein the one or more properties of the rendered image comprise one or more selected from the list consisting of: a type of the second virtual scene, one or more properties of one or more light sources in the second virtual scene, and image brightness.

12. The image processing method of claim 1, wherein rendering an image of a second virtual scene comprises:
rendering a sequence of images of virtual scenes for content; and wherein generating the output image comprises generating, by the NST model, a sequence of output images using the sequence of rendered images as content images, each output image corresponding to a respective rendered image.

13. The image processing method of claim 12, wherein generating, by the NST model, the sequence of output images comprises:
using the same 3D volumetric effect sampling results as the style image for each rendered image; the method further comprising inputting a time-varying control signal to the NST model for animation of the volumetric effect depicted in the sequence of output images.

14. The image processing method of claim 12, further comprising:
obtaining a sequence of 3D volumetric effect sampling results depicting a volumetric effect animation; wherein generating the sequence of output images comprises using respective 3D volumetric effect sampling results as style images for respective rendered images.

15. The image processing method of claim 1, wherein the NST model comprises:
a generative adversarial network “GAN” comprising a generative neural network and a discriminator network; wherein the generative neural network is trained to generate an output image using a content image and 3D volumetric effect sampling results as the style image; and wherein the discriminator neural network is trained using training data comprising images of scenes including a volumetric effect so as to classify output images generated by the NST model as being one of fake images generated by the NST model and real images.

16. The image processing method of claim 1, wherein the volumetric effect comprises one or more from the list consisting of:
a volumetric fog effect;
a volumetric smoke effect;
a volumetric water effect;
a volumetric fire effect; and
a volumetric mobile particles effect.

17. An image processing system for generating images including a volumetric effect, the system comprising:
a sampling processor configured to obtain three-dimensional “3D” volumetric effect sampling results from a simulation of a volumetric effect for a first virtual scene;
a rendering processor configured to render an image of a second virtual scene; and
an neural style transfer “NST” model trained to generate an output image in dependence on a style image and a content image, the NST model being configured to:
receive the 3D volumetric effect sampling results for the first virtual scene, and the rendered image of the second virtual scene as inputs; and
generate an output image for the second virtual scene using the rendered image of the second virtual scene as the content image and the 3D volumetric effect sampling results for the first virtual scene as the style image.

18. The image processing system of claim 17, wherein the 3D volumetric effect sampling results for the first virtual scene comprise volumetric effect data sampled using a frustrum voxel grid.

19. One or more non-transitory computer-readable storage media storing instructions that when executed by one or more computers cause the one or more computers to perform operations for generating images including a volumetric effect, wherein the operations comprise:
obtaining three-dimensional “3D” volumetric effect sampling results from a simulation of a volumetric effect for a first virtual scene;
rendering an image of a second virtual scene;
inputting the 3D volumetric effect sampling results for the first virtual scene, and the rendered image of the second virtual scene to a neural style transfer “NST” model trained to generate an output image in dependence on a style image and a content image; and
generating, by the NST model, an output image for the second virtual scene using the rendered image of the second virtual scene as the content image and the 3D volumetric effect sampling results for the first virtual scene as the style image.

20. The non-transitory computer-readable storage media of claim 19, wherein the 3D volumetric effect sampling results for the first virtual scene comprise volumetric effect data sampled using a frustrum voxel grid.
